(19) United States
(12) Patent Application Publication
(10) Pub. No.: US 2026/0054368 A1
(43) Pub. Date: Feb. 26, 2026

(54) QUICK CONNECTION TOOL HANDLE

(71) Applicant: Steven Clark, Buffalo, KY (US)

(72) Inventor: Steven Clark, Buffalo, KY (US)

(21) Appl. No.: 19/281,565

(22) Filed: Jul. 26, 2025

Related U.S. Application Data
(60) Provisional application No. 63/681,141, filed on Aug. 8, 2024.

(51) Int. Cl. B25G 3/28; A47L 13/51; B25G 1/04; B25G 3/26; E04H 4/16

(52) U.S. Cl. CPC B25G 3/28; A47L 13/51; B25G 1/04; B25G 3/26; E04H 4/1609

(57) ABSTRACT

A quick-release connector comprising a male portion and female portion, wherein the male portion has at least one outwardly facing key congruent with an at least one inwardly facing keyway of the female portion. The male portion includes a spring-biased plunger protruding from a leading end which provides a biasing force sufficient to securely seat the key into an internal pocket of the female member upon rotation and release of the male portion, thereby ensuring rotational and axial alignment between the male and female portion. The male portion and female portion can be affixed to a handle and toolhead, respectively, so that a handle can quickly be swapped between multiple toolheads.

### FIELD OF THE INVENTION

The present invention relates to a quick-connect and release connector for attaching a removeable handle to a tool working head. More particularly, the present invention relates to a quick-connect and disconnect fitting having a male part with protruding keys which axially and rotationally mate with the keyway of a female fitting, thereby allowing the handle of the male fitting to be quickly attached and detached from various tool working heads.

### BACKGROUND OF THE INVENTION

Various tools require an elongated handle to allow a user to effectively complete their required tasks. For instance, a broom head is attached to a handle to allow a user to clean floors while in a standing position. A feather dusting head may be attached to an elongated handle to allow the user to reach the corners of their ceilings or high shelves. Further, activities such as pool cleaning require the use of an elongated pole to remove leaves from the surface of the pool using a net, and then scrubbing the walls and floor of the pool using a bristle-brush.

In many cases, such as with pool cleaning, it is impractical for a user to have tools with permanently integrated handles. Such tools require ample space for storage and can quickly clutter a tool shed or closet. Furthermore, the heads of such tools may become worn and require replacement long before the handle loses its effectiveness. Considering these issues, removable tool handles have been utilized for many years to allow a single handle to be used in conjunction with multiple tool heads—increasing the effective functionality of the handle and reducing overall tool costs. Often the head will have to be removed and reattached several times during a cleaning operation which can be time consuming a physically exhausting when changing conventional mounted heads as opposed to the quick exchange heads of the instant invention.

U.S. Pat. No. 5,375,286 to Harrah discloses a quick-release connector for connecting a handle to a tool head, said connector having a first section with a plurality of receptacles for receiving at least one bayonet projection of a second section, wherein the first section is mounted to the handle and the second section is mounted to the tool head. The second section has preferably three bayonet projections, linearly arranged, wherein the two outer bayonets are inwardly flexible to allow the first section to slidingly engage over the two outer bayonets, which relax and interlock with the receptacles of the first section when properly aligned. To separate the first and second sections of the connector, a user may squeeze the outer bayonets to disengage the bayonets from the receptacles. The first section of the connector includes a polygonal shallow recess which mates with a similar polygonal protrusion in the second section to provide torsional resistance during use. While the disclosed invention does provide a means by which to quickly connect and disconnect a tool head and handle, and further provide torsional resistance, the connector necessitates that a user must interact with the “dirty” end of the handle; the dirty end being that which is near the tool head which may be used for activities such as cleaning, i.e. a mophead.

U.S. Pat. No. 6,824,180 to Tomchak discloses another quick-release connector assembly wherein the male portion can be mounted to the end of a handle and includes a pair of resilient arms extending upward and outward from the bottom end of the male portion, with outwardly facing teeth protruding from each arm. The male portion can be received by a female portion which has inwardly facing teeth meant to interlock with the outwardly facing teeth of the male portion to ensure a secure connection. The base of the female portion is angled inward so to abut an angled surface on the male portion when the male portion is inserted into the female portion. Providing multiple teeth on each the male and female portions permits the handle to be secured at whatever depth is required for the angled surfaces to abut, thereby accounting for any variations on the diameter between the male and female portions. Despite ensuring a snug fit, the disclosed invention suffers a similar disadvantage as the patent to Harrah in that it still requires a user to interact with a dirty end of the handle.

U.S. Pat. No. 6,254,303 to Falat et al. discloses a quick-release connector for industrial machine tools that allows for easy replacement of tool heads while maintaining axial and rotational stability. The connector comprises a female member with a receiving end having an outer collar with an internal recess defined therein, an inner sleeve fitted into the internal recess, and a means for biasing the outer collar towards the receiving end relative to the inner sleeve, where the inner sleeve is movable axially relative to the outer collar. Further included is a male member that is reversibly and coaxially engageable with the female member, having a shaft extending from the leading end with nubs extending radially to act as a first set of keys to engage with a first keyway disposed in an inner bore of the inner sleeve. When the male member is engaged with the female member, the misalignment of the first set of keys and first keyway inhibits the axial movement between the male member and the inner sleeve of the female member. Further, a second set of keys on the male member, axially offset from the first set of keys may engage with a second keyway disposed in said collar to prevent rotational movement between the male and female members. The male member cannot be disengaged from the female member without the user releasing the collar from the inner sleeve, against the means for biasing the outer collar towards the receiving end. The design of the disclosed invention provides a robust means by which to secure a tool head to a handle and provide axial and rotational alignment. However, such as the previously mentioned inventions, the removal of the male member requires the user to manipulate the dirty end of the handle by sliding the collar prior to removing the tool head.

U.S. Pat. No. 7,574,768 to Morris et al. discloses a quick-release handle for use with the working head of a cleaning tool. The quick-release coupling assembly is positioned on one end of the handle and a button actuator, operably connected to the coupling assembly, is positioned on the opposite end of the handle. Depression of the button actuator disengages the coupling assembly so that the handle can be removed from a socket mount of the working head. While the disclosed invention overcomes the disadvantages of the previous by providing a means to disengage the tool head without interacting with the dirty end of the handle, it still has its own limitations. A disadvantage of the disclosed invention is that handle may not be of a telescoping or multi-segmented variety, since there is no means by which the button actuator may remain operably connected to the coupling assembly.

What is desired, therefore, is a quick-release connector which provides both axial and rotational alignment between a handle and a tool head. What is further desired is a quick-release connector which a user can disengage without manipulating the dirty end of the handle near the tool head. It is yet a further desire that the quick-release connector may be compatible with handles which are extendable, such as of a telescoping or segmented variety.

### SUMMARY OF THE INVENTION

Accordingly, it is an object of the present invention to provide a quick-release connector which provides both axial and rotational alignment between a handle and tool head.

It is another object of the invention to provide a quick-release connector which can be disengaged by the user without requiring manipulation of the dirty end of the handle.

It is yet another object of the invention to provide a quick-release connector which can be used on extendable handles, such as telescoping or segmented handles or poles.

It is a further object of the invention to provide a quick-release connector solution which can be added to existing tool handles or be built integrally into the handle during manufacturing.

To overcome the deficiencies of the prior art and to achieve at least some of the objectives and advantages listed, herein is disclosed a quick-release connector comprising or consisting of a female portion with a receiving end and a mounting end, each having an internal recess defined therein which are separated by an internal wall. The mounting end of the female portion is attached to a tool head so that the receiving end faces away from the tool head and there is no axial or rotational movement between said female portion and said tool head. The internal recess of the receiving end includes inwardly and radially defined keyways in the side walls through which congruent outwardly facing keys of a male portion of the quick-release connector can pass therethrough. Once said keys of the male portion pass through said keyways of the female portion, the male portion can be rotated and the keys retracted into pockets which are radially defined in the side walls of the receiving end of the female portion and are adjacent to said keyways.

The male portion of the quick-release connector comprises or consists of a hollowed cylindrical sleeve, having openings on a leading end and a mounting end. The mounting end of the male portion is affixed to a handle so that the leading end faces away from said handle and there is no rotational or axial movement between said male portion and said handle. The outer diameter of the male portion is less than the internal diameter of the receiving end of the female portion so that the leading end of the male portion may be inserted into the receiving end when the outwardly facing keys of the male portion are aligned with said keyways of the female portion.

The male portion further includes a plunger, biasing spring, and compression block which reside in said hollowed cylindrical sleeve. Said plunger includes a stem which extends outward through the opening of the leading end and a head which is too large in diameter to pass through the opening of the leading end. The biasing spring is held in compression against the head of said plunger by the compression block, which interlocks with channels recessed into the interior sidewalls of said cylindrical sleeve.

When a user inserts said male portion into said female portion, the stem of said plunger contacts the internal wall of the female portion and must be compressed to pass said keys of the male portion through the keyways of said female portion. Once the keys pass through said keyways, the user may rotate the handle, and thereby the male portion, so that the keys align with said pockets of the female portion. Rotating the keys to align and retract into said pockets allows the plunger to extend. The force exerted by the biasing spring onto the plunger ensures that the male portion remains properly seated within the female portion to ensure an axial and rotational fastening between the two portions of the quick-release connector. When a user is ready to decouple the male and female portions, the plunger must be recompressed into the male portion and the keys realigned with the keyways of said female portion.

Concisely, the invention described herein illustrates a quick-release connector, comprising, consisting, and consisting essentially of a female portion including a receiving end having an internal recess with a back wall therein, wherein alignment features protrude radially inward from the sidewalls of said internal recess, wherein said alignment features include an at least one keyway, an at least one near-side wall radially adjacent to said at least one keyway, an at least one pocket radially adjacent to said near-side wall, and an at least one far-side wall radially adjacent to said pocket; a male portion including a hollowed cylindrical sleeve having a leading end with an opening through which a stem of a plunger may protrude, wherein the opposite end of said plunger provides a head against which a compression spring may be compressed towards a compression block distal to the leading end; said male portion further including an at least one outwardly facing key proximal to said leading end of said hollowed cylindrical sleeve, wherein said outwardly facing key interacts with said alignment features of the female portion during coupling of said male and female members and is seated into the at least one pocket of the female member, biased by said compression spring, to ensure rotational and axial alignment of said male and female members.

The invention further includes a method of quickly connecting a toolhead to a handle or pole, comprising, consisting, and consisting essentially of the steps of providing a quick-release connector, comprising a female portion including a receiving end having an internal recess with a back wall therein, wherein alignment features protrude radially inward from the sidewalls of said internal recess, wherein said alignment features include an at least one keyway, an at least one near-side wall radially adjacent to said at least one keyway, an at least one pocket radially adjacent to said near-side wall, and an at least one far-side wall radially adjacent to said pocket; a male portion including a hollowed cylindrical sleeve having a leading end with an opening through which a stem of a plunger may protrude, wherein the opposite end of said plunger provides a head against which a compression spring may be compressed towards a compression block distal to the leading end; said male portion further including an at least one outwardly facing key proximal to said leading end of said hollowed cylindrical sleeve, wherein said outwardly facing key interacts with said alignment features of the female portion during coupling of said male and female members and is seated into the at least one pocket of the female member, biased by said compression spring, to ensure rotational and axial alignment of said male and female members; aligning said at least one outwardly facing key of said male portion with an at least one inwardly facing keyway of said female portion; inserting said male portion into said female portion with pressure until said key traverses the entire length of said keyway, and said compression spring is compressed by the retraction of said plunger due to interference with the back wall of said internal recess; rotating said male portion until said key aligns with said pocket of the female portion; and releasing pressure from said male portion so that the compression spring may extend and bias said key into said pocket, thereby ensuring rotational and axial alignment of said male and female members.

There has thus been outlined, rather broadly, the more important features of this invention in order that the detailed description thereof that follows may be better understood, and in order that the present contribution to the art may be better appreciated. There are, of course, additional features of the invention that will be described hereinafter and which will form the subject matter of the claims appended hereto.

### BRIEF DESCRIPTION OF DRAWINGS

The accompanying drawings are incorporated into and form a part of the specification to illustrate examples of the aspects, embodiments, or configurations disclosed herein. The drawings together with the description, are meant to explain the principal aspects, embodiments, or configurations of the invention. The drawings illustrate preferred and alternative examples of the aspects, but are not intended to limit the aspects, embodiments, or configurations to only the illustrated and described examples. Further features and advantages will become apparent from the following, more detailed, description of the various aspects, embodiments, or configurations, as illustrated by the drawings referenced below. Reference numbers are the same for those elements that are the same across different Figures.

FIG. 1 is a cross-sectional perspective view of a decoupled quick-release connector according to a first embodiment of the present invention;

FIG. 2 is a cross-sectional right plan view of a female portion of the quick-release connector according to a second embodiment of the present invention;

FIG. 3 is a cross-sectional right plan view of the female portion of the quick-release connector of FIG. 1;

FIG. 4 is a cross-sectional right plan view of the male portion of the quick-release connector of FIG. 1;

FIG. 5 is a cross-sectional right plan view of a male portion of the quick-release connector according to a third embodiment of the present invention;

FIG. 6 is a detailed cross-sectional view of a male portion of the quick-release connector according to a fourth embodiment of the present invention;

FIG. 7 is a cross-sectional view of the quick-release connector of FIG. 1 in an initial alignment configuration, A;

FIG. 8 is a cross-sectional view of the quick-release connector of FIG. 1 in an aligned and compressed configuration, C;

FIG. 9 is a cross-sectional view of the quick-release connector of FIG. 1 in a compressed and rotated configuration, R;

FIG. 10 is a cross-sectional view of the quick-release connector of FIG. 1 in a seated configuration, S;

FIG. 11 is a perspective view of a quick-release connector according to a fifth embodiment of the present invention;

FIG. 12 is a top plan view of an integrated quick-release connector according to a sixth embodiment of the present invention;

FIG. 13 is a perspective view of an exemplary embodiment of a quick-release connector implemented in an envisioned field application.

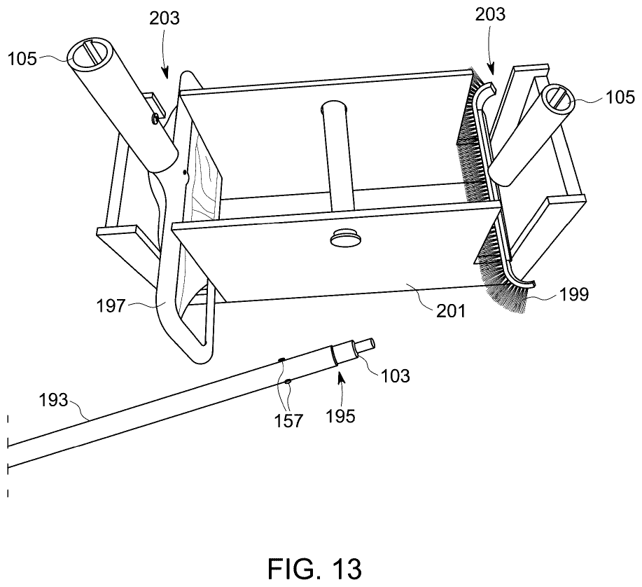

### DETAILED DESCRIPTION OF THE INVENTION

Various embodiments of the present invention are described herein and depicted in the drawings. To acquaint persons skilled in the pertinent arts most closely related to the present invention, a preferred embodiment that illustrates the best mode now contemplated for putting the invention into practice is described herein by, and with reference to, the annexed drawings that form a part of the specification. This exemplary embodiment is described in detail without attempting to describe all the various forms and modifications in which the invention might be embodied. As such, the embodiments described herein are illustrative and, as will become apparent to those skilled in the arts, may be modified in numerous ways within the scope and spirit of the invention.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature structure, or characteristic in connection with other embodiments, whether or not explicitly described.

Unless otherwise indicated, all numbers expressing quantities, dimensions, conditions, and so forth used in the specification and claims are to be understood as being modified in all instances by the term “about. ” The term “a” or “an” entity, as used herein, refers to one or more of that entity. As such, the terms “a”or “an”, “one or more”and “at least one”can be used interchangeably herein.

The use of “including,” “comprising,” or “having,” and variations thereof herein is meant to encompass the items listed thereafter and equivalents thereof as well as additional items. Accordingly, the terms “including,” “comprising,” or “having,” and variations thereof can be used interchangeably herein.

It shall be understood that the terms “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials, or acts and the equivalents thereof shall include all those described in the summary of the invention, brief description of the drawings, detailed description, abstract, and claims themselves.

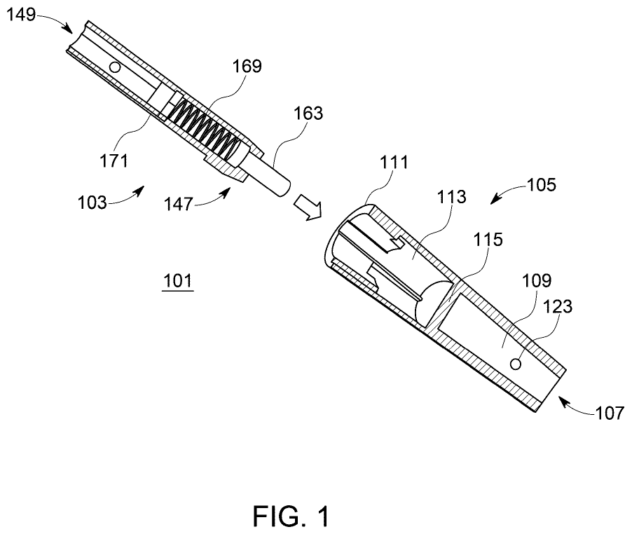

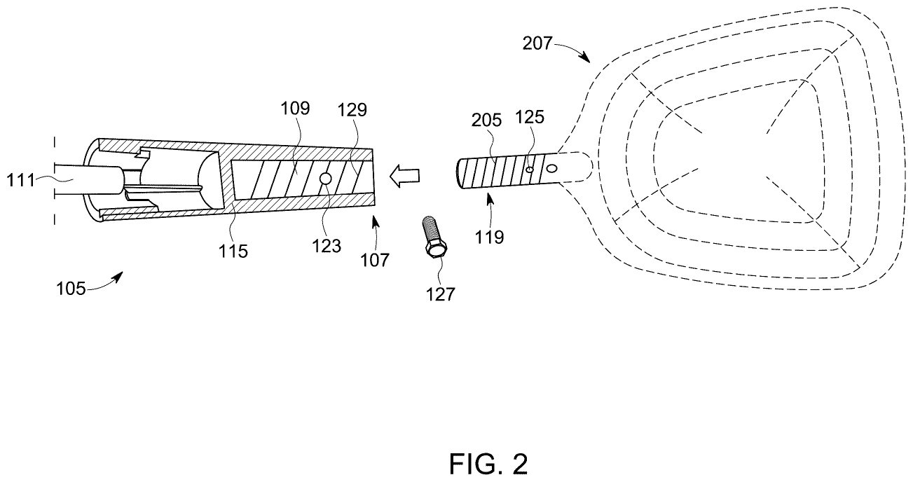

Referring now to FIG. 1, a preferred embodiment of quick-release connector 101 comprising a male portion 103 and a female portion 105 is shown as a cross sectional exploded view in a decoupled configuration. The female portion 105 includes a mounting end 107, having an internal recess 109, and a receiving end 111, having an internal recess 113. The internal recesses of said mounting and receiving ends are separated by an internal wall 115. The internal recess 109 of the mounting end 107 has a diameter large enough to receive a similarly shaped mounting tube 119 of a tool head 121. In a preferred embodiment the mounting end 107 of the female portion 105 includes at least one bolt hole 123 which aligns with at least one bolt hole 125 in the mounting tube 119 through which a first retaining means such as a bolt 127, cotter pin, screw, pin or the like may axially and rotationally affix said female portion 105 to said tool head 121. Additionally, or alternatively, the mounting end 107 of the female portion may include internal threads 129 to fasten to the external threads 131 of a tool head 133, as illustrated in FIG. 2.

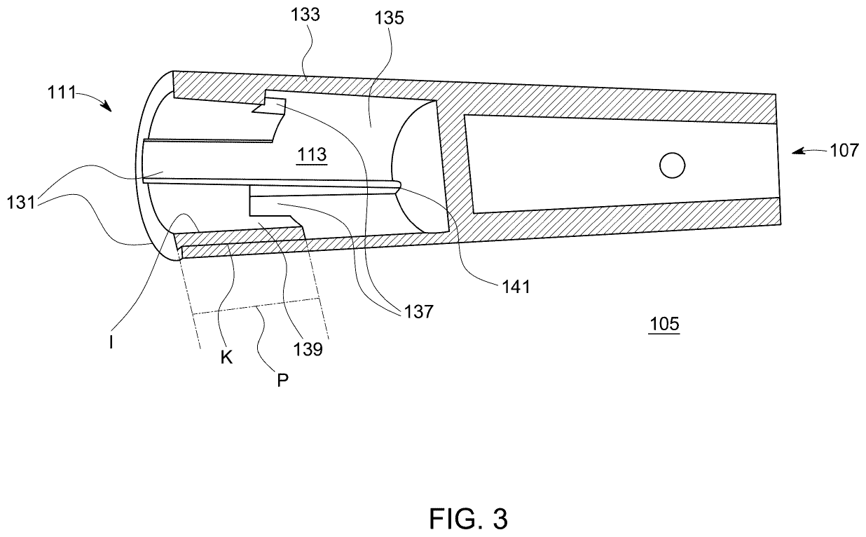

Further detailed in FIG. 3, the internal recess 113 of the receiving end 111 of the female portion 105 includes at least one keyway 131 radially and inwardly defined from the sidewall 133 of the receiving end. The at least one keyway 131 has a passage length P, a key diameter K, and an internal diameter I. Beyond the passage length P of the keyway 131, the internal recess 113 radiates outward to at least the key diameter K to create a rotational cavity 135. At least one pocket 137 per keyway 131 is formed into said sidewall 133 radially adjacent to the keyway, wherein the at least one pocket has a width at least as large as the keyway, with a near-side wall 139 and a far-side wall 141. In the preferred embodiment, the far-side wall 141 extends the length of the internal recess to act as a hard stop, thereby limiting the rotational movement of the key so that the key may be easily seated into the pocket.

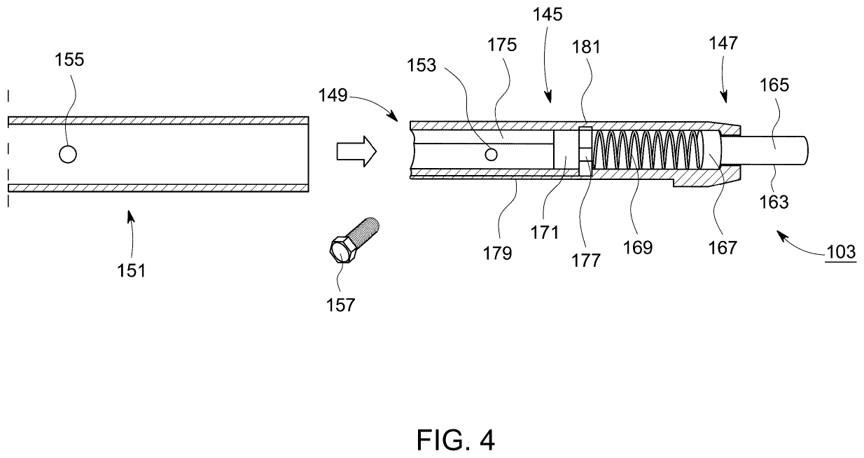

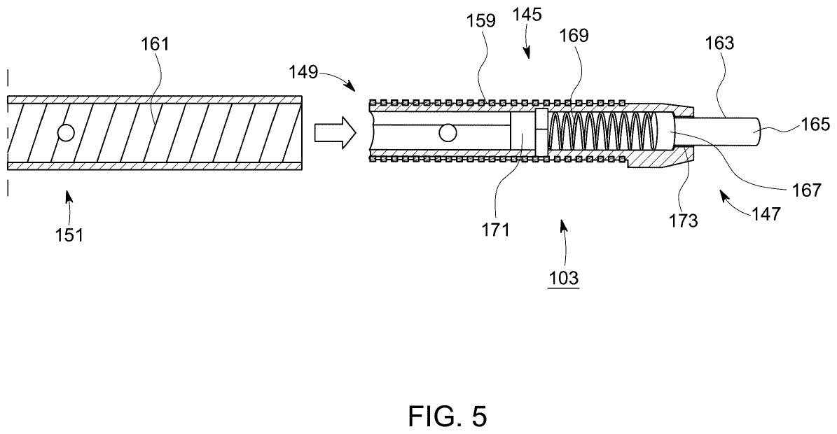

The male portion 103 of the quick-release connector 101, further detailed in FIG. 4, comprises a hollowed cylindrical sleeve 145 having a leading end 147 and a mounting end 149. The external diameter of the mounting end 149 of the male portion 103 is appropriately sized so that it may slide inside the tube of a handle 151. In a preferred embodiment the mounting end 149 of the male portion 103 includes at least one bolt hole 153 which aligns with at least one bolt hole 155 in the tube of a handle 151 through which a second retaining means such as a bolt 157, cotter pin, or the like may axially and rotationally affix said male portion 103 to said handle 151. Additionally, or alternatively, the mounting end 149 of the male portion may include external threads 159 to fasten to the internal threads 161 of a handle 151, as illustrated in FIG. 5.

The male portion 103 further includes a plunger 163, biasing spring 169, and compression block 171 which reside in said hollowed cylindrical sleeve 145. Said The plunger includes a stem 165 which extends outward through an opening 173 of the leading end 147, and a head 167 which is too large in diameter to pass through the opening of the leading end. The compression block 171 has at least one wing 177 extending outwardly from its base to interlock with an internal channel 179 which is recessed into the sidewalls of the cylindrical sleeve 145. A slot 183 is defined in the end of the compression block 171 opposite the base so that a tool such as a screwdriver may be inserted into said slot to push the compression block down the length of the internal channel 179 until the at least one wing 177 is adjacent to a transverse channel 181 into which it may be rotated, thereby locking it into place. In this locked position, the compression block 171 provides a compressive force against the biasing spring 169, which is coupled on the opposite end to the head 167 of said plunger 163. The compressive force exerted by the compression block is dependent upon the stiffness of the spring and the distance it is compressed. In the preferred embodiment, only a single transverse channel 181 is provided along the internal channel 179, and the compressive force is set to an optimal setting for a user of average strength.

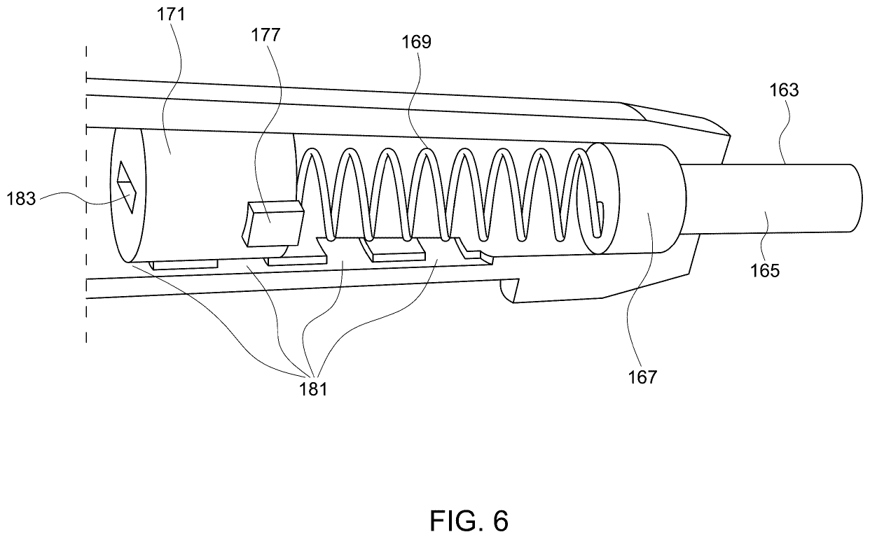

While greater compressive forces ensure a more secure attachment of the tool head, to accommodate users of varying strength it may be advantageous to provide multiple transverse channels incrementally spaced along the length of the main internal channel. As illustrated in FIG. 6 in an alternative embodiment, an incremental array of transverse channels 175 may be recessed into the sidewalls of the cylindrical sleeve to allow the compression block to be inserted at varying depths and thereby allow for various amounts of compressive force.

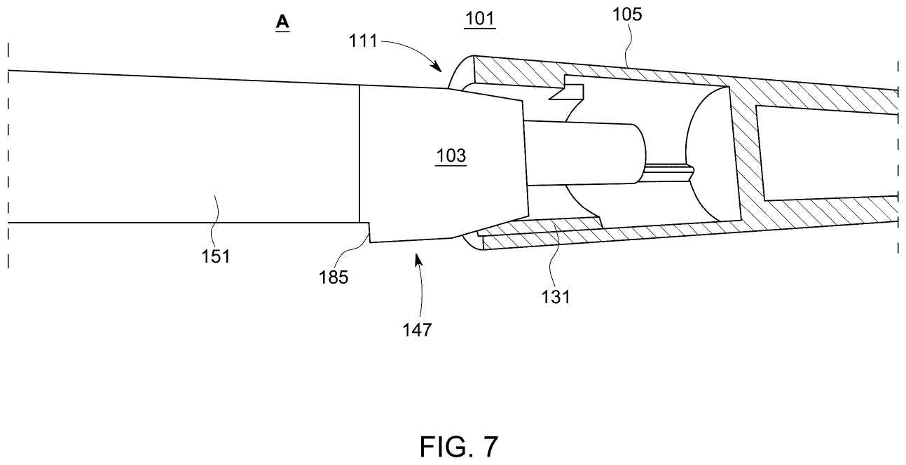

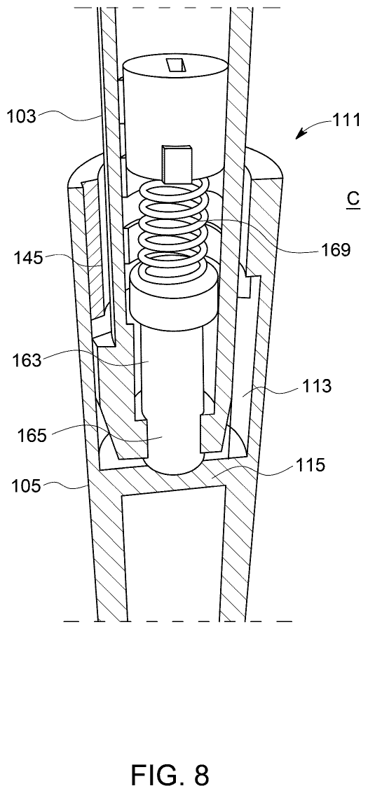

Operation of the quick-release connector 101 will now be described in accordance with FIGS. 7-10. The outer diameter of the male portion 103 and handle 151 is less than the internal diameter of the receiving end 111 of the female portion 105 so that the leading end 147 of the male portion may be inserted with force into the receiving end 111 when an at least one outwardly facing key 185 of the leading end 147 of the male portion 103 is aligned with an at least one congruent keyway 131 of the receiving end 111 of the female portion 105, as illustrated in FIG. 7 in an initial alignment configuration, A. As the male portion is inserted into said female portion, the stem 165 of the plunger 163 contacts the internal wall 115 of the internal recess 113 of the receiving end of the female portion, thereby causing the plunger to retract into the hollowed cylindrical sleeve 145 of the male portion 103 and compressing the biasing spring 169 of the male portion, as illustrated in FIG. 8 in an aligned and compressed configuration, C.

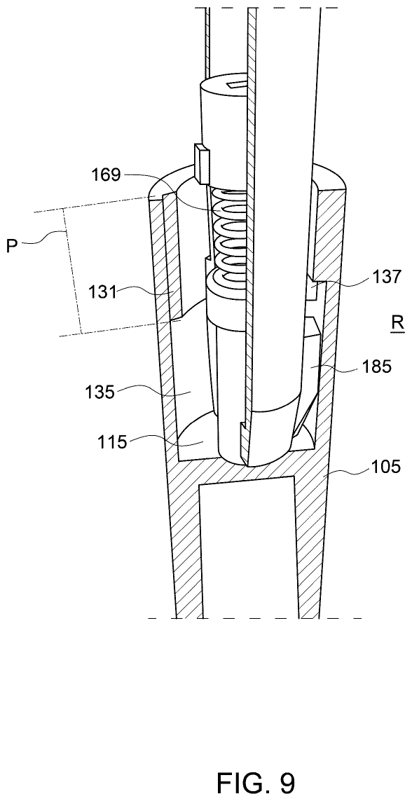

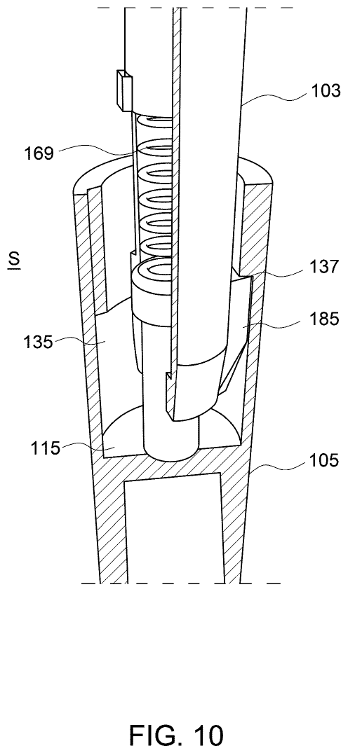

After the at least one outwardly facing key 185 of the male portion passes through the passage length P of the keyway 131 of the female portion 105, the entirety of the key 185 is located in the rotational cavity 135 of the female portion. The male portion 103 may then be rotated by the user, often using a handle 151 rotationally and axially affixed to the mounting end 149 of said male portion, to misalign the key and keyway, and thereby prevent the compressive forces of the biasing spring 169 from ejecting the male portion from the female portion. The male portion may continue to be rotated until the outwardly facing key 185 contacts the far-side wall 141 (not shown) of the rotational cavity 135, as illustrated in FIG. 9 in a compressed and rotated configuration, R. Once fully rotated, the key 185 may be seated into the pocket 137 of the rotational cavity, biased by the spring 169 once the user relieves the force exerted against the spring, as illustrated in FIG. 10 in a seated configuration, S. The force exerted by the biasing spring ensures the male portion 103 remains rotationally and axially secured to the female portion 105, and thereby the handle 151 rotationally and axially secured to the tool head 121.

When a user is ready to decouple the male and female portions, an opposite sequence may be used wherein the user exerts a compressive force against the biasing spring 169 and plunger 163 so that the outwardly facing key 185 of the male portion 103 may be unseated from the pocket 137 of the female portion to a compressed and rotated configuration R, then rotated in a direction opposite the far-side wall 141 to be realigned with the keyway 131 in an aligned and compressed configuration C, and then withdrawn from the female member to the initial alignment configuration, A.

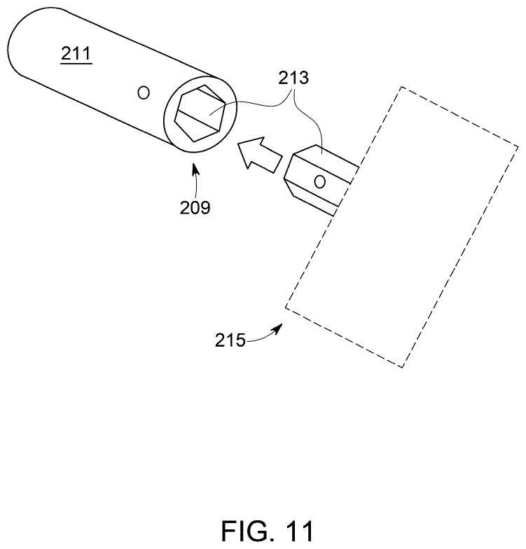

In the preferred embodiment, the mounting end 107 of the female portion 105 and the mounting end 149 of the male portion 103 are cylindrical. However, it would be apparent to one skilled in the art that the mounting end of either the male or female portion may be manufactured in a polygonal design if such was necessary to properly attach the male or female portion to a handle or tool head, respectively, as illustrated as an alternative embodiment in FIG. 11. It will further be appreciated that the mounting end of either male or female portion could be made sufficiently large or sufficiently small to either receive or be inserted into a particular useful attachment.

Therefore, what is described herein is a quick-release connector which provides both axial and rotational alignment between a handle and tool head, can be engaged and disengaged by the user without requiring manipulation of the dirty end of the handle, and which can be implemented for use on any style handle, including extendable handles such as telescoping or segmented handles and poles. The final objective of the invention herein is realized in an additional alternative embodiment illustrated in FIG. 11, wherein a female portion 187 is integrated unitarily with a toolhead of interest 189, and a male portion 191 is integrated unitarily with a handle 193.

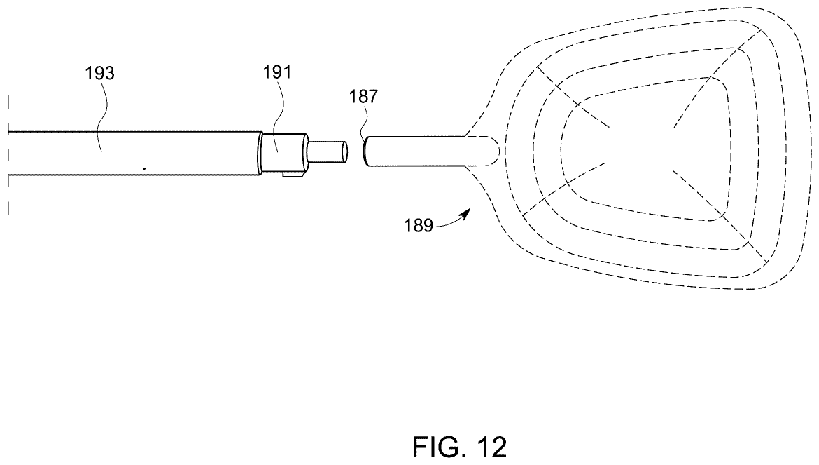

An exemplary application of said quick-release connector is illustrated in FIG. 12, wherein said male portion 103 is inserted into a working end 195 of a pool handle 193 and fastened with a bolt 157. Said female portion 105 is fastened to a pool skimmer 197 and a scrub brush 199 using bolts, which are held in a caddie 201. Said caddie has at least one tool slot 203 for holding a toolhead upright so that the male portion may be easily engaged or disengaged with the female portion attached to any toolhead in said caddie.

The disclosure has been described with reference to various specific embodiments and techniques. However, it should be understood that many variations and modifications may be made while remaining within the spirit and scope of the invention. It is therefore appreciated that certain features of the invention, which are, for clarity, described in the context of separate embodiments, may also be provided in combination in a single embodiment. Conversely, various features of the invention that are, for brevity, described in the context of a single embodiment, may also be provided separately or in any sub-combination.

What is claimed is:

1. A quick-release connector, comprising:
a female portion including a receiving end having an internal recess with a back wall therein, wherein alignment features protrude radially inward from the sidewalls of said internal recess, wherein said alignment features include an at least one keyway, an at least one near-side wall radially adjacent to said at least one keyway, an at least one pocket radially adjacent to said near-side wall, and an at least one far-side wall radially adjacent to said pocket;
a male portion including a hollowed cylindrical sleeve having a leading end with an opening through which a stem of a plunger may protrude, wherein the opposite end of said plunger provides a head against which a compression spring may be compressed towards a compression block distal to the leading end;
said male portion further including an at least one outwardly facing key proximal to said leading end of said hollowed cylindrical sleeve, wherein said outwardly facing key interacts with said alignment features of the female portion during coupling of said male and female members and is seated into the at least one pocket of the female member, biased by said compression spring, to ensure rotational and axial alignment of said male and female members.

2. The quick-release connector of claim 1 wherein said female member includes a mounting end and said male member includes a mounting end, each used for attachment to a multitude of various toolheads, handles, or poles.

3. The quick release connector of claim 2, wherein said mounting end of said male member and said mounting end of said female member have at least one thru-hole through which a bolt or cotter pin may be used to fasten said multitude of various toolheads, handles, or poles having an at least one corresponding thru-hole.

4. The quick-release connector of claim 2 wherein said mounting end of said male member and said mounting end of said female member are cylindrical.

5. The quick-release connector of claim 2 wherein said mounting end of said male member and said mounting end of said female member are polygonal to match a polygonal mounting end of said multitude of various toolheads, handles or poles.

6. The quick-release connector of claim 2, wherein said mounting end of said male member and said mounting end of said female member have internal or external threading for fastening to said multitude of various toolheads, handles, or poles.

7. The quick-release connector of claim 1 wherein said female member is unitarily integrated into a toolhead and said male member is unitarily integrated with a handle or pole.

8. The quick-release connector of claim 1 wherein said compression block has an at least one wing extending outwardly from its base to interlock with an internal channel recessed into the side wall of said hollowed cylindrical sleeve, whereby said wing may be rotated into a transverse channel to lock the depth of said compression block.

9. The quick-release connector of claim 8 wherein said internal channel has a multitude of transverse channels recessed into the side wall of said hollowed cylindrical sleeve, thereby providing a means by which to vary the depth of said compression block and thereby the compression applied to said spring.

10. A method of quickly connecting a toolhead to a handle or pole, comprising:
providing a quick-release connector, comprising:
a female portion including a receiving end having an internal recess with a back wall therein, wherein alignment features protrude radially inward from the sidewalls of said internal recess, wherein said alignment features include an at least one keyway, an at least one near-side wall radially adjacent to said at least one keyway, an at least one pocket radially adjacent to said near-side wall, and an at least one far-side wall radially adjacent to said pocket;
a male portion including a hollowed cylindrical sleeve having a leading end with an opening through which a stem of a plunger may protrude, wherein the opposite end of said plunger provides a head against which a compression spring may be compressed towards a compression block distal to the leading end;
said male portion further including an at least one outwardly facing key proximal to said leading end of said hollowed cylindrical sleeve, wherein said outwardly facing key interacts with said alignment features of the female portion during coupling of said male and female members and is seated into the at least one pocket of the female member, biased by said compression spring, to ensure rotational and axial alignment of said male and female members;
aligning said at least one outwardly facing key of said male portion with an at least one inwardly facing keyway of said female portion;
inserting said male portion into said female portion with pressure until said key traverses the entire length of said keyway, and said compression spring is compressed by the retraction of said plunger due to interference with the back wall of said internal recess;
rotating said male portion until said key aligns with said pocket of the female portion;
and releasing pressure from said male portion so that the compression spring may extend and bias said key into said pocket, thereby ensuring rotational and axial alignment of said male and female members.

11. The method of claim 10 wherein the male member of the quick-release connector further comprises an internal channel recessed into the side wall of said hollowed cylindrical sleeve, said internal channel having a multitude of traversing channels wherein an at least one wing extending from the base of said compression block may interlock with said channels, and wherein the compression block is adjusted to a desired depth to alter the compression forces of the compression spring for various applications.

12. The method of claim 10 wherein said female member is unitarily integrated into said toolhead and said male member is unitarily integrated with said handle or pole.

13. The method of claim 10 wherein said mounting end of said male member and said mounting end of said female member further include at least one thru-hole through which a bolt or cotter pin may be used to fasten said toolheads, handles, or poles having an at least one corresponding thru-hole; and further comprising mounting said female portion and said male portion to said toolheads, handles, or poles prior to engagement of said male and female portions.

14. The method of claim 10 wherein said toolhead is held upright in a caddie so that either said male portion or female portion attached to said toolhead is readily accessible by a user having said handle or pole having the matching male or female portion.

15. The quick-release connector of claim 2 wherein said toolhead is a pool skimmer or bristle brush.

16. The quick-release connector of claim 2 wherein said handle or pole is an extendable kind such as a segmented or telescoping handle or pole.
